(19) United States
(12) Patent Application Publication
(10) Pub. No.: US 2026/0296902 A1
(43) Pub. Date: Oct. 1, 2026

(54) PRODUCING SILICA NANOPARTICLES DURING MINERAL CARBONATION

(71) Applicant: Wisconsin Alumni Research Foundation, Madison, WI (US)

(72) Inventors: Bu Wang, Madison, WI (US); Md Sariful Sheikh, Madison, WI (US)

(73) Assignee: Wisconsin Alumni Research Foundation, Madison, WI (US)

(21) Appl. No.: 19/093,601

(22) Filed: Mar. 28, 2025

(51) Int. Cl. C01B 33/18; C01F 5/24; C01F 11/18; C22B 34/12

(52) U.S. Cl. CPC C01B 33/18; C01F 5/24; C01F 11/181; C22B 34/1254; C01P 2002/72; C01P 2002/85; C01P 2002/88; C01P 2004/03; C01P 2004/62; C01P 2004/64; C01P 2006/12

(57) ABSTRACT

An integrated method to synthesize silica nanoparticles and recover critical metals from leachates produced from mineral carbonation. The method includes adding a zwitterion (e.g., an amino acid) into a Si-rich carbonation leachate, where the zwitterion instigates silica precipitation by complexing with aqueous Si species and serving as nucleation agents. During this process, the pH of the leachate is minimally affected, allowing the solution to be recycled for mineral carbonation. The resulting silica nanoparticles can be filtered out, washed with a mild acidic solution to remove impurities, and resuspended in a basic solution. The critical metals retained in the leachate after silica precipitation can be recovered using chemical precipitation or electrodialysis.

### FEDERAL FUNDING STATEMENT

This invention was made with government support under 2132022 awarded by the National Science Foundation and under DE-AR0001636 awarded by the DOE/ARPA-E. The government has certain rights in the invention.

### BACKGROUND

Silica nanoparticles, characterized by their high surface area and unique physicochemical properties, have significant industrial applications, including the use as an additive in cement to enhance mechanical strength and durability, and a key component in various nanotechnology-based products.

Commercial silica nanoparticles are prepared using various methods including sol-gel method using silica precursors tetraethyl orthosilicate (TEOS), flame synthesis method using silicon-containing gases (like silane), chemical reaction (e.g., pH swing) using silica sources like sodium silicate, mechanical grinding of bulk silica, and hydrothermal synthesis using high temperature and pressure. See e.g., Rahman, I. A.; Padavettan, V. “Synthesis of Silica Nanoparticles by Sol-Gel: Size-Dependent Properties, Surface Modification, and Applications in Silica-Polymer Nanocomposites—A Review.” J. Nanomater. 2012, 132424; Yue, R.; Meng, D.; Ni Y.; Jia Y.; Liu G.; Yang J.; Liu H.; Wu X.; Chen Y. “One-step flame synthesis of hydrophobic silica nanoparticles.” Powder Technol. 2013, 235: 909-913; Nguyen, H-H.; Nguyen, T. T. H.; Kim, J. K.; Cho, Y-S. “Synthesis of Silica Nanoparticles from Sodium Silicate and Carbon Dioxide as Reactants.” Arch. Metall. Mater. 2024, 69(2): 453-457.

The existing technology requires high-grade raw Si containing chemicals, high energy consumption, and can include multiple synthesis steps. While some of them provide unique benefits such as the ability to achieve ultra-high purity and uniform particle size, many commercial applications with large potential market sizes, such as using silica nanoparticles as fillers and in concrete, do not require such features.

The atmospheric CO₂ level has risen sharply to an alarming level of 425 ppm in 2024, compared to ~320 ppm in 1960. This increase in atmospheric CO₂ is a major driver of global warming, leading to adverse environmental effects such as rising sea levels, more frequent extreme weather events, ocean acidification, ecosystem shifts, and potential agricultural disruptions due to the altered weather conditions. In response, most countries signed the 2015 Paris Agreement, committing to reach net-zero carbon emission by 2050. Common approaches to achieve this goal include transitioning to renewable energy sources, balancing CO₂ emissions with carbon capture and utilization, and reducing fossil fuel consumption. However, a complete transition to green energy remains challenging in the short term. Therefore, implementing effective carbon capture, utilization, and storage (CCUS) strategies is crucial to curb CO₂ emissions and mitigate the existing atmospheric CO₂ levels.

The industries all over the world produces a huge amount of alkaline solid wastes annually (coal fly ash~1000 Mt, blast furnace slag~390 Mt, waste gypsum~220 Mt, and steel slag~240 Mt). In total, up to 4.02 Gt of CO₂ could be sequestered through the mineralization of these industrial alkaline wastes, corresponding to 12.5% of annual global anthropogenic CO₂ emissions. This highlights the significant potential of CO₂ mineralization using industrial alkaline wastes. The industrial wastes, particularly power plant fly ash, steel slag, and blast furnace slag, are rich in elements such as calcium (Ca), silicon (Si), aluminum (Al), sulfur (S), iron (Fe), and magnesium (Mg) in varying proportions. In the mineralization process, industrial waste is added to an aqueous alkaline or acidic solution, where cations are leached from the solid waste into the solution. CO₂ bubbling or adding carbonate to this solution precipitates carbonates such as CaCO₃, MgCO₃ and FeCO₃, while other cations, such as Si and Al, remain in the solution. However, the process faces challenges due to the extensive consumption of the acidic/alkaline reagents and the slow reaction kinetics of traditional mineralization process. Additionally, the accumulation of non-precipitating cations like Si and Al in the leachate slows further cation leaching and reduces carbonation efficiency, complicating the cyclic process. These non-precipitated elements can typically be removed by inducing a large pH swing, but this approach is costly and energy intensive.

To make this CO₂ mineralization process economically viable it is important to extract value added by-products from this process. By-products like value-added nano-silica recovery from the process could help to maintain the carbonation performance and balance the cost of CO₂ mineralization. Industrial wastes such as power plant fly ash, steel slags, and blast furnace slags contain a significant amount of Si in addition to the Ca. Extraction of this Si as a nano-silica as a by-product of the mineralization process with minimal additional cost could be advantageous over the commercial nano-silica synthesis processes.

Stopic et al. reported a method for synthesizing silica nanoparticles through the carbonation of olivine under high pressure in an autoclave (Stopic, S.; Dertmann, C.; Koiwa, I.; Kremer, D.; Wotruba, H.; Etzold, S.; Telle, R.; Knops Pol.; Friedrich, B. “Synthesis of Nanosilica via Olivine Mineral Carbonation under High Pressure in an Autoclave,” Metals. 2019, 9: 708). However, this approach is energy intensive due to the requirement for high pressure and the use of an autoclave.

Additionally, various industrial wastes contain critical metals. For example, coal fly ash contains 0.06% to 0.30% Li as Li₂O, and steel slag contains small amounts of titanium (Ti), nickel (Ni), and cobalt (Co). However, traditional extraction methods are energy-intensive and costly, making them impractical due to the low concentrations of these metals. At the same time, critical metals such as lithium, nickel, cobalt, titanium, copper, and rare earth elements are highly important for the transition to clean energy, modern technologies, and economic growth. As the U.S. aims to decarbonize its power sector and economy by 2035 and 2050, respectively, securing a future supply of these materials is crucial. The Department of Energy (DOE) Loan Programs Office (LPO) estimates that the clean energy transition will require a substantial increase in global critical metal production compared to current levels. Furthermore, high-quality ores used in conventional extraction methods are dwindling. Therefore, developing strategies for recovering critical metals from secondary sources and enhancing extraction expertise are important.

There remains an unmet need for a cost-effective method of producing silica nanoparticles and recovering critical metals during mineral carbonation. Such a method would not only enhance the commercial viability of mineral carbonation but also contribute to the development of advanced materials with reduced environmental impact.

### SUMMARY

Disclosed herein is an integrated method to synthesize silica nanoparticles and recover critical metals from leachates produced from mineral carbonation. Mineral carbonation is a method for carbon removal that is widely recognized for its potential to durably sequester carbon dioxide (CO₂) at large scale. Minerals used for ex situ carbonation, where the carbonation occurs on the ground (as opposed to in underground geological formations), include ground natural minerals and various industrial alkaline wastes like steel slags, coal fly ash, etc. These minerals contain Ca- and/or Mg-silicates, from which the Ca and Mg ions can be extracted in an aqueous environment to react with CO₂ and mineralize it into solid carbonate. This process often accelerates the dissolution of the silica atomic network that originally encapsulated the Ca and Mg ions, producing a carbonation solution (leachate) that contains elevated concentrations of Si. The Si concentration is particularly significant when the carbonation is performed in basic conditions. A high dissolved Si concentration can inhibit mineral carbonation at high pH. As such, it is desirable to remove the Si before the carbonation solution is recycled/reused. Simultaneously, precipitating the Si out of the solution in the form of fine amorphous silica is also desired because such materials have high market values.

Specifically, disclosed and claimed herein is a method of synthesizing silica nanoparticles and recovering critical metals, the method comprising:
(a) providing a first solution containing dissolved silica, wherein the first solution is obtained by carbonation of a silicate-containing feedstock; and
(b) adding a zwitterion to the carbonation solution in an amount sufficient to precipitate at least a portion of the dissolved silica to yield silica nanoparticles.

The zwitterion suitable for use is not limited. Typically, it comprises an acidic group with a low pKa value (like in amino acids, from about 1.0 to about 4.0), and a basic group with a relatively high pKa (like in amino acids from 6.0 to 13.0). The zwitterion may be selected from the group consisting of amino acids, amino sulfonic acids, betaines, sulfobetaines, and phosphobetaines. In one version, the zwitterion is an amino acid. Non-limiting examples of the amino acid include lysine and glycine.

The silica nanoparticles resulting from the method may have an average size ranging from about 20 nm to about 350 nm, and a surface area ranging from about 50 m²/g to about 250 m²/g, as measured by the Brunauer-Emmett-Teller (BET) method.

In one version, the carbonation of the silicate-containing feedstock comprises contacting the silicate-containing feedstock with gaseous CO₂ in an aqueous alkaline solution or an aqueous alkaline solution containing soluble carbonate or bicarbonate salts to produce precipitated alkaline earth carbonates. The method further comprises mechanically separating the precipitated alkaline earth carbonates from the aqueous alkaline solution to obtain the first solution.

The silicate-containing feedstock suitable for use in the carbonation step is not limited. Any silicate-containing material may be used. The material may comprise a ground natural mineral or an industrial alkaline waste. Non-limiting examples of the ground natural mineral include olivine, serpentine, pyroxene, amphibole, feldspar, and wollastonite. Non-limiting examples of the industrial alkaline waste include fly ash, bottom ash, slag, mine tailings, red mud, cement kiln dust, and crushed concrete.

In step (b), the precipitation may be conducted at around room temperature, and for a time ranging from about 5 minutes to about 24 hours.

The method may further comprise, following step (b), step (c), which includes mechanically separating the yielded silica nanoparticles from the first solution to obtain separated silica nanoparticles and a second solution.

The method may further comprise, following step (c), step (d), which includes washing the separated silica nanoparticles with an acidic solution having an H⁺ concentration of less than 0.5 N. The wash removes impurities from the silica nanoparticles. In one version, the acidic solution is HNO₃ with a concentration of about 0.001 N.

In one version, the silicate-containing feedstock comprises at least one metal selected from cobalt (Co), copper (Cu), lithium (Li), titanium (Ti), nickel (Ni), niobium (Nb), tantalum (Ta), vanadium (V), tungsten (W), and rare earth metals, wherein at least a portion of the metal is present in the second solution. The method may further comprise recovering at least a portion of the metal from the second solution using various standard techniques, including, but not limited to, precipitation, electrodialysis, membrane separation, solvent extraction, ion exchange, adsorption, and evaporation.

Due to the use of the zwitterion, the pH of the carbonation solution is minimally affected during the silica nanoparticle precipitation, allowing the solution to be recycled for mineral carbonation. Thus, the pH of the second solution may differ from the first solution by no more than 2 units, and the method may further comprise, following step (c), step (e), which includes recycling the second solution into the carbonation of the silicate-containing feedstock, and repeating one or more cycles of steps (a), (b), (c), and (e).

In one version, the silicate-containing feedstock comprises at least one metal selected from cobalt (Co), copper (Cu), lithium (Li), titanium (Ti), nickel (Ni), niobium (Nb), tantalum (Ta), vanadium (V), tungsten (W), and rare earth metals, wherein the concentration of the metal in the second solution increases with each cycle of steps (a), (b), (c), and (e). The method may further comprise recovering at least a portion of the metal from the second solution after the one or more cycles of steps (a), (b), (c), and (e) using various standard techniques, including, but not limited to, precipitation, electrodialysis, membrane separation, solvent extraction, ion exchange, adsorption, and evaporation.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1. A schematic representation of the CO₂ mineralization, nano-silica synthesis, and titanium recovery using industrial waste steel slags.

FIG. 2. Panel (a) shows thermogravimetric mass change of CaCO₃ and the released CO₂ gas concentration in the TGA chamber outlet during heating in N₂ gas. Panel (b) shows TGA profile of the carbonated steel slag.

FIG. 3. Concentration of element leached in the leachate as a function of NaOH concentration.

FIG. 4. X-ray photo emission spectroscopy of the precipitated nano-silica before and after acid wash.

FIG. 5. XRD patterns of the dried precipitation before washing with dilute acid (0.001 N HNO₃)

FIGS. 6A-6B. FIG. 6A shows XRD pattern of the silica nanoparticles recovered using glycine and lysine. FIG. 6B shows N₂ adsorption-desorption histogram at 77 K of the recovered nano-silica prepared using glycine and lysine additives. Inset shows the optical image of the recovered nano silica dispersed in water.

FIGS. 7A-7D. FESEM images and particle size histogram of the silica nanoparticles prepared using 1.25 M glycine (FIGS. 7A and 7B) and 1.25 M lysine (FIGS. 7C and 7D) after 1 h precipitation time.

FIGS. 8A-8B. FIG. 8A shows total surface area measurement using BET method with N₂ adsorption (P/Pₒ~0.05 to 0.3) histogram at 77 K. FIG. 8B shows CO₂ and N₂ adsorption-desorption histogram of the precipitated silica at room temperature (295 K).

FIGS. 9A-9D. pH changes of the leachate after adding glycine (FIG. 9A) and lysine (FIG. 9C). Silica ion remained in the leachate as function of concentration and precipitation time of the added glycine (FIG. 9B) and lysine (FIG. 9D).

FIG. 10. FESEM image of the carbonated steel slag represents the large particle size.

### DETAILED DESCRIPTION

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

The elements and method steps described herein can be used in any combination whether explicitly described or not.

All combinations of method steps as used herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in the art. The disclosure provided herein suitably may be practiced in the absence of any element which is not specifically disclosed herein.

It is understood that the disclosure is not confined to the particular ingredients, compositions of matter, or steps herein illustrated and described, but embraces such modified forms thereof as come within the scope of the claims.

Disclosed herein is a method to synthesize silica nanoparticles from leachates produced from mineral carbonation.

Mineral carbonation is a chemical process in which carbon dioxide (CO₂) reacts with naturally occurring or synthetic minerals to form stable carbonate compounds, such as CaCO₃, MgCO₃, and FeCO₃. This process may occur under natural or engineered conditions, typically involving water to dissolve CO₂ and facilitate the reaction with minerals, resulting in sequestration of CO₂ in a solid form. In some scenarios, carbonate ions (CO₃²⁻) or bicarbonate ions (HCO₃⁻) may be introduced into the solution to enhance the carbonation process by providing a readily available source of carbonate for reaction with cations such as Ca²⁺, Mg²⁺, or Fe²⁺. In the present disclosure, mineral carbonation refers to ex situ carbonation, where the carbonation takes place above ground in a controlled environment, rather than in underground geological formations.

When silicate-containing minerals are used for carbonation, the Ca, Mg, or Fe ions can be extracted from the Ca-, Mg-, or Fe-silicates in an aqueous environment. These ions react with CO₂ to form solid carbonates through mineralization. This process often accelerates dissolution of the silica atomic network that originally encapsulates the Ca, Mg or Fe ions, producing a carbonation solution (leachate) that contains elevated concentration of dissolved silica species.

The conditions for mineral carbonation are not limited. In one version, the process is conducted in an alkaline solution (e.g., NaOH) or an aqueous alkaline solution containing soluble carbonate or bicarbonate salts at elevated temperatures, typically ranging from 50 to 200° C. Following carbonation, the precipitated carbonates can be separated from the solution to recover the leachate, such as through filtration.

The leachate is typically an aqueous solution comprising dissolved silica species, metal cations such as Ca²⁺, Mg²⁺, and Fe²⁺ released during mineral dissolution, and anions such as carbonate (CO₃²⁻) or bicarbonate (HCO₃⁻) formed from the reaction of CO₂ with water. Additional trace ions and minor components originating from impurities in the minerals (e.g., Al and S species) may also be present, depending on the specific mineral feedstock. The dissolved silica species, derived from the silicate minerals, are primarily present as silicic acid (H₄SiO₄) in low-pH or neutral solutions. In alkaline solutions, silicic acid dissociates stepwise to form ions such as H₃SiO₄⁻ and H₂SiO₄²⁻, with the degree of dissociation increasing as the pH rises.

The silicate-containing minerals may be a natural ground mineral or an industrial alkaline waste. Exemplary natural silicate minerals include, but are not limited to, olivine (e.g., Mg₂SiO₄, Fe₂SiO₄), serpentine (e.g., Mg₃(Si₂O₅)(OH)₄), pyroxene (e.g., MgSiO₃, CaMgSi₂O₆), amphibole (e.g., Ca₂Mg₅Si₈O₂₂(OH)₂), feldspar (e.g., CaAl₂Si₂O₈), and wollastonite (CaSiO₃). Exemplary industrial alkaline wastes include, but are not limited to, fly ash (e.g., coal fly ash), bottom ash, slag (e.g., steel slag and blast furnace slag), mine tailings, red mud (bauxite residue), cement kiln dust, and crushed concrete.

The method disclosed herein comprises adding a zwitterion to the Si-rich carbonation leachate to precipitate the dissolved silica species as silica nanoparticles.

As used herein, a “zwitterion” refers to a molecule that contains both a positively charged group and a negatively charged group within the same molecule, resulting in an overall neutral charge.

In one version, the zwitterion is an amino acid. The term “amino acid” as used herein refers to a molecule containing both an amino group (—NH₂) and a carboxylic acid group (—COOH). Amino acids may be naturally occurring or synthetic, and can include standard proteinogenic amino acids (e.g., lysine, glycine), non-proteinogenic amino acids (e.g., β-alanine, γ-aminobutyric acid), modified amino acids (e.g., phosphorylated, acetylated, or methylated derivatives), and amino acid analogs or derivatives, which retain the structural features of an amino acid but may have substitutions, modifications, or alternative functional groups. Amino acids may exhibit chirality, existing as D- or L-enantiomers, or as racemic mixtures. The pKa range of amino acids typically spans 2.0-2.5 for the carboxylic acid group and 9.0-10.5 for the amino group, with variations depending on the side chain structure.

Other zwitterions containing an acidic group with a pKa similar to the carboxylic acid group of amino acids, typically ranging from 1.0 to 3.0, are also suitable for use. Non-limiting examples of zwitterions other than amino acids include amino sulfonic acids, betaines, sulfobetaines, and phosphobetaines.

As used herein, the term “amino sulfonic acid” refers to a class of organic compounds containing at least one amino group (—NH₂) and one sulfonic acid group (—SO₃H) within the same molecule. Amino sulfonic acids may include linear, branched, or cyclic structures and can feature additional functional groups or substituents, provided the core amino and sulfonic acid moieties are retained. They can be naturally occurring or synthetically derived. Non-limiting examples of amino sulfonic acids include taurine (2-aminoethanesulfonic acid), homotaurine (3-aminopropanesulfonic acid), and cysteic acid (2-amino-3-sulfopropanoic acid).

As used herein, the term “betaine” refers to a class of zwitterionic compounds containing a quaternary ammonium group (—NR₄⁺) and a carboxylate group (—COO⁻) within the same molecule. The general structure can be represented as R₁R₂R₃N⁺—(CH₂)ₙ—COO⁻, where R₁, R₂, and R₃ are substituents attached to the nitrogen atom and can be hydrogen, alkyl, or aryl groups, and n represents the number of methylene units in the connecting chain. Betaines can be naturally occurring, such as glycine betaine (trimethylglycine), or synthetically derived. They may also include derivatives or analogs modified by substitutions on the nitrogen or carbon atoms, provided the zwitterionic structure is maintained.

As used herein, the term “sulfobetaine” refers to a subclass of zwitterionic compounds that contain a quaternary ammonium group (—NR₄⁺) and a sulfonate group (—SO₃⁻) within the same molecule. The general structure can be represented as R₁R₂R₃N⁺—(CH₂)ₙ—SO₃⁻, where R₁, R₂, and R₃ are substituents attached to the nitrogen atom (e.g., hydrogen, alkyl, or aryl groups), and n represents the number of methylene units in the connecting chain.

As used herein, the term “phosphobetaine” refers to a subclass of zwitterionic compounds containing a quaternary ammonium group (—NR₄⁺) and a phosphate group (—PO₄²⁻) within the same molecule. The general structure can be represented as R₁R₂R₃N⁺—(CH₂)ₙ—PO₄²⁻, where R₁, R₂, and R₃ are substituents on the nitrogen atom (e.g., hydrogen, alkyl, or aryl groups), and n represents the number of methylene units in the connecting chain. Phosphobetaines are naturally occurring in some biological systems, and can also be synthetically produced.

The form of the zwitterion added to the carbonation solution is not limited. In one version, the zwitterion is added in solid form, such as a powder. Alternatively, the zwitterion may be added as a solution, where it is dissolved in a solvent. The solvent includes inorganic and organic solvents.

The zwitterion initiates silica precipitation by complexing with aqueous Si species and serving as nucleation agents. During this process, the zwitterion acts as a buffer and maintains a stable chemical environment. Thus, the pH of the leachate is minimally affected, allowing the solution to be recycled for mineral carbonation. This is attractive compared to the traditional method of inducing silica precipitation through a pH swing (by adding mineral acid or CO₂ to the solution), where the reduction of pH renders the reuse of the solution difficult. The amino acid concentration and precipitation time can be varied to control the size of the silica nanoparticles, which is also difficult to achieve using pH swing methods. During this process, the zwitterions do not precipitate with silica and instead remain mostly in the solution. In certain versions, at least about 85%, at least about 90%, at least about 91%, at least about 92%, at least about 93%, at least about 94%, at least about 95%, at least about 96%, at least about 97%, at least about 98%, at least about 99%, or about 100% of the zwitterions remain in the solution.

The conditions for the precipitation of silica nanoparticles are not limited. The precipitation may be conducted at around room temperature. Lower temperatures may enhance the precipitation due to the reduced solubility of the elements. The duration of precipitation can vary from about 5 minutes to about 24 hours.

The resulting silica nanoparticles can be filtered out, washed with a mild acidic solution (e.g., <0.5 M HNO₃), and subsequently resuspended or redispersed in a basic solution.

The resulting silica nanoparticles typically have an average size ranging from about 20 nm to 350 nm, and a specific surface area ranging from 50 m²/g to 250 m²/g, as measured by the Brunauer-Emmett-Teller (BET) method.

In contrast to the conventional sol-gel method that uses tetraethyl orthosilicate (TEOS) as a silica precursor, the present method utilizes inorganic silica derived from mineral carbonation. A major benefit of the amino acid assisted precipitation technology described in this disclosure is that it allows silica nanoparticle production to be integrated into mineral carbonation processes. By doing so, silica nanoparticles can become a co-product of the carbon removal processes with minimal additional costs (i.e., the cost of amino acid and modest increases in liquid storage and filtration capacity).

The silica nanoparticles produced from the method can be used for lower end applications with large market sizes, such as concrete industry. Commercial efforts have been made in recent years to market silica nanoparticle-based products to concrete producers and users. The main issue is the cost and agglomeration which reduces their effectiveness in concrete. The present disclosure offers a cost-effective approach to address the challenges and facilitate the integration of silica nanoparticles into the concrete industry.

Also disclosed herein is a method for recovering critical metals integrated with processes of CO₂ carbonation and silica nanoparticle synthesis. Various industrial waste contains small amounts of critical metals, including, but not limited to, lithium, nickel, cobalt, titanium, copper, niobium, tantalum, vanadium, tungsten, and rare earth metals. We have discovered that during CO₂ carbonation, these metals are leached into the solution, and during the synthesis of silica nanoparticles, they remain in solution rather than precipitating with silica nanoparticles. Consequently, when the solution is recycled, the metal concentration gradually increases with each cycle. Once sufficiently concentrated, the metals can be recovered using any techniques known in the art, including, but not limited to precipitation, electrodialysis or membrane separation, solvent extraction, ion exchange, adsorption, and evaporation.

### Examples

CO₂ mineralization using alkaline industrial waste has a great potential for CO₂ sequestration. However, the sluggish reaction kinetics and huge consumption of base or acid reagents make this technology impractical. In this Example, we have integrated important aspects of industrial waste utilization i.e. value-added product and critical metal recovery along with the CO₂ mineralization process. Nano-silica synthesis and critical metal recovery, previously separate commercial processes, are now integrated with the CO₂ mineralization process. This integrated process will be beneficial for the practical implementation of the CO₂ mineralization technology as the nano-silica and critical metal titanium has commercial value to cover the cost of the mineralization process. Additionally, this integrated process provide advantage over the commercial nano-silica synthesis and titanium extraction process as this process allows their extraction in a relatively cost-effective way compared to the individual processes. This integrated technique studied for the steel slags can be used for other types of alkaline solid industrial waste like coal fly ash, cement kiln dust, etc.

### Methods

### Mineralization of Steel Slag

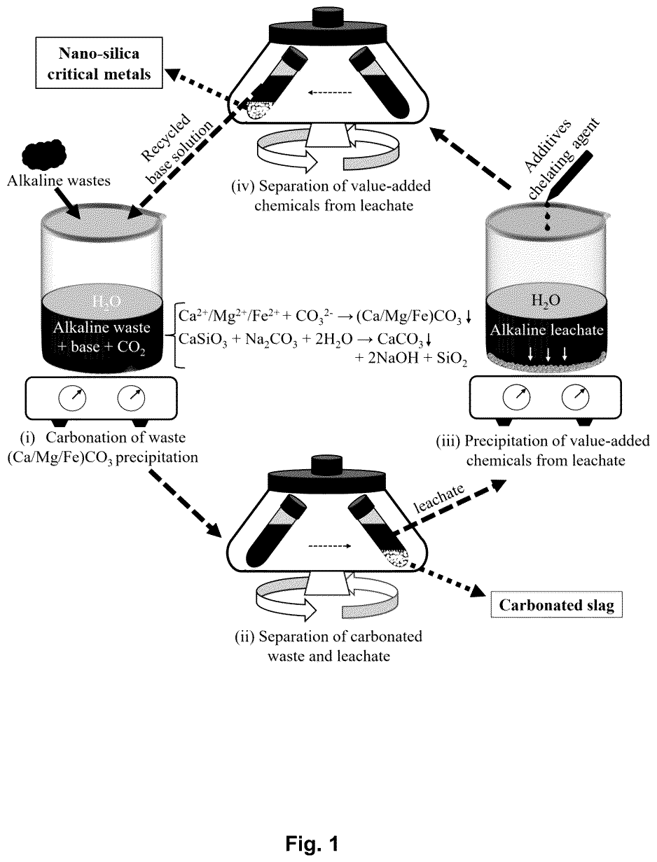

The CO₂ mineralization of powdered steel slag was performed in a plastic beaker using an aqueous basic solution. At first, 40 gm of steel slag was added in 1 litre of basic solution containing 1M NaOH and 1M Na₂CO₃. The mixture was then stirred for 24 h using a magnetic stirrer on a hot plate at room temperature (step i in FIG. 1). The OH⁻ group in the basic solutions leaches out the metal ions from the steel slag. Alkaline metal ions specially Ca reacts with the CO₃²⁻ and HCO₃⁻ present in the solution and precipitate as CaCO₃. After the mineralization process, the carbonated slag was separated from the mixture by centrifugation (step ii in FIG. 1). The basic leachate which contains Si, Al, Ca, Na, S, Ti, etc., elements leached from the slag was divided in 50 ml centrifuge tubes.

### Silica Recovery

To precipitate silica from the leachate, amino acid additives glycine and lysine were added to the leachate at a concentration of 0, 0.1, 0.25, 0.5, 0.75, 1 and 1.25 M, kept at room temperature for time in the range from 30 min to 24 h (step iii in FIG. 1). During this period, mostly Si, Al and Na precipitates by the amino acid additives. The precipitated silica was separated by centrifugation (step iv in FIG. 1). The separated solid was washed with water, 0.001 N HNO₃ and water in succession. In one batch of samples, the separated solid was washed 3 times with water only. The washed silica nanoparticle was dried in an oven at 95° C.

### Characterizations

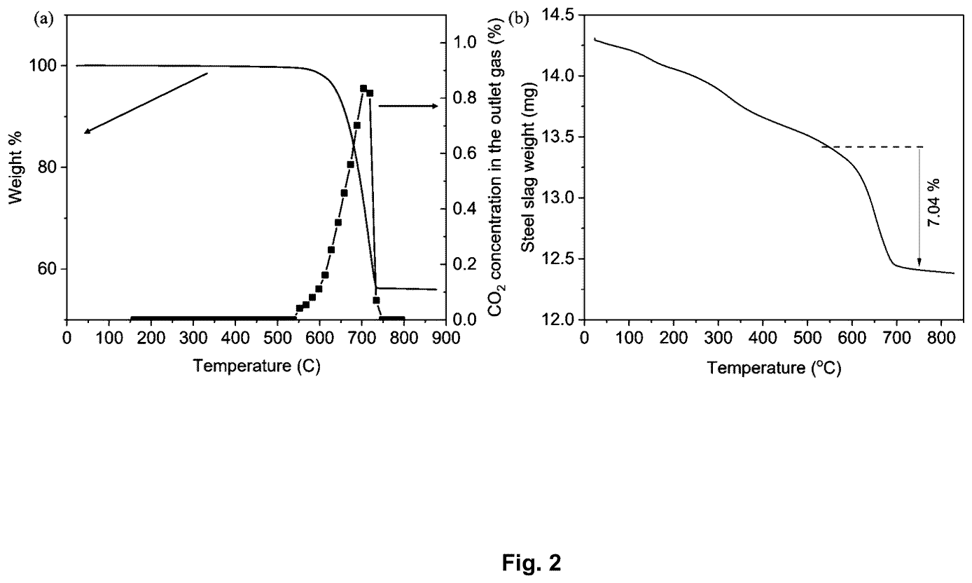

The structural characterization of the precipitated nano-silica sample was performed using the room-temperature X-ray diffraction technique using Cu Kα source (Bruker D8 Discover; Bruker Corporation, Billerica, MA). The morphology of the recovered silica nanoparticles was studied using a field-emission scanning electron microscope (ZEISS 1530; Carl Zeiss AG, Oberkochen, Germany). XPS analysis was performed using a Thermo K-Alpha X-ray photoelectron spectrometer (Al Kα source) (Thermo Fisher Scientific, Waltham, MA). The concentration of various elements in the leachate was studied using an Inductively Coupled Plasma—Optical Emission Spectrometry (Agilent Technologies, Santa Clara, CA; Model: 5800 VDV ICP-OES). For the elemental analysis of the basic leachate, its pH was reduced below 2 by adding nitric acid before the measurement. To determine the percentage of various elements in the steel slag and carbonated steel slag, it was first dissolved in 15 N nitric acid and then it was diluted before the ICP-OES measurement (pH-1S). The percentage of carbonation of the carbonated slag was estimated using thermogravimetry (TA Instruments, New Castle, DE; Model TGA Q550). The carbonated slag was heated in nitrogen gas environment and its mass change was recorded. The carbonation percentage was estimated as the mass percentage change between the 540 to 750° C. of the TGA data of carbonated slag. To determine the temperature range where the carbonated sample (mainly the precipitated CaCO₃ present in the steel slag) releases CO₂, we first used CaCO₃ powder as calibration material. The CaCO₃ powder was heated using a TGA instrument in N₂ environment (gas flow 10 sccm) and the concentration of CO₂ gas in the outlet of the TGA chamber was simultaneously recorded using a gas chromatography. We observed that CaCO₃ starts releasing CO₂ at around 540° C. and completely decomposes at 750° C. (FIG. 2). Hence, the percentage of mass change between 640-750° C. in the TGA data profile was considered as the percentage of mineralized CO₂ in the carbonated steel slag. Nitrogen adsorption desorption isotherm measurements were carried out at 77 K using a Quantachrome instrument (Model: autosorb iQ7). The specific surface area of SNP was measured by the Brunauer-Emmett-Teller (BET) method using adsorption isotherm in the relative pressure range 0.05 to 0.3.

### Results and Discussion

### Synthesis of Silica Nanoparticles

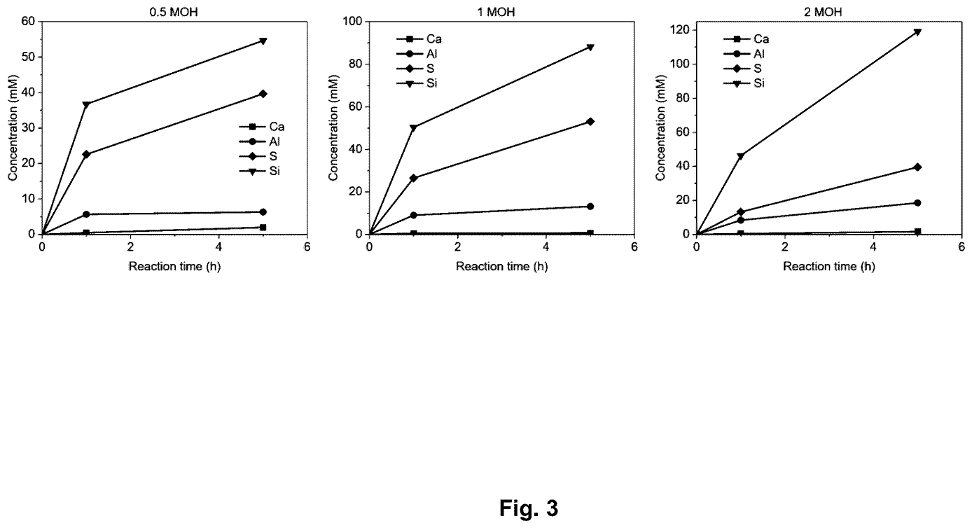

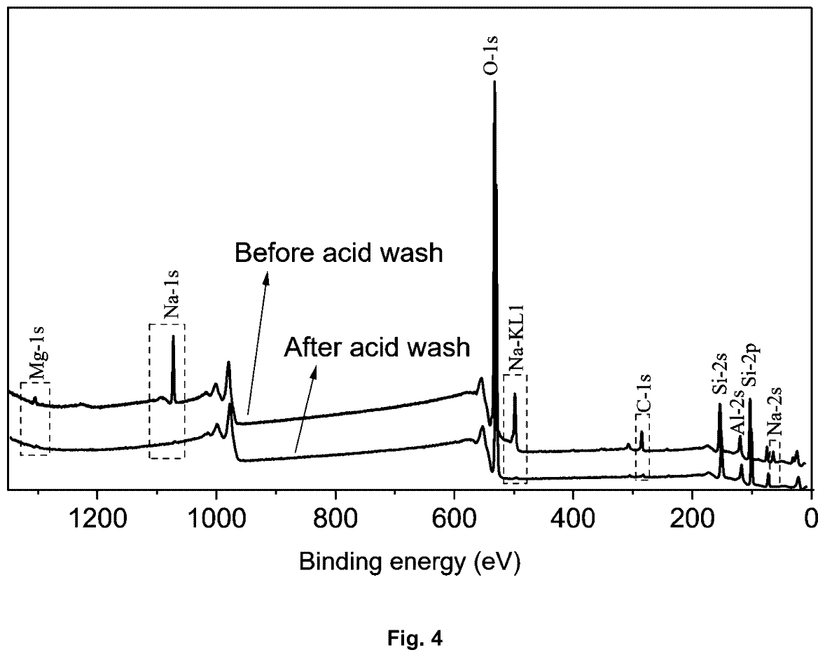

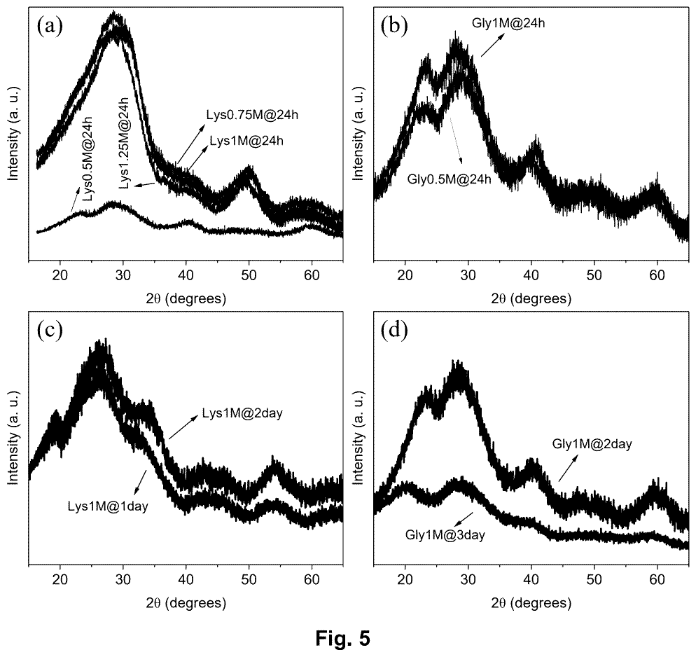

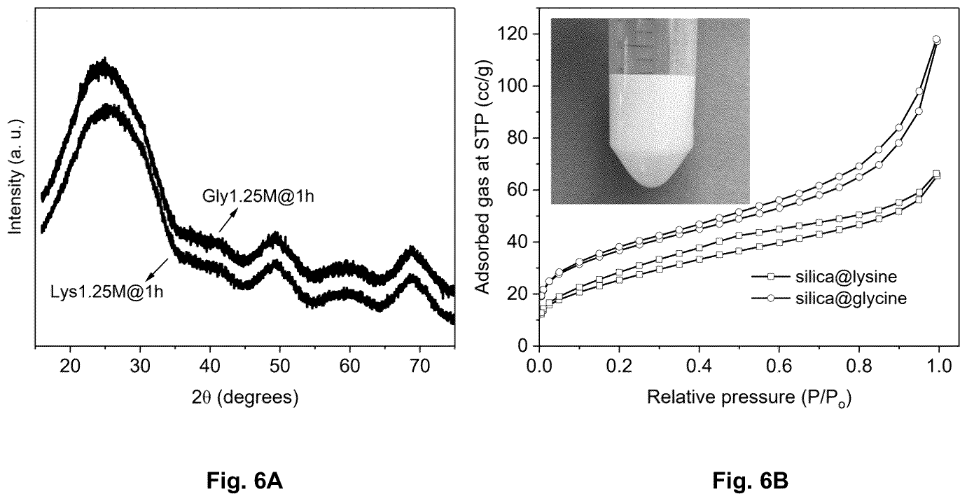

To measure the concentration of various major elements leached in the solution during the carbonation process (after step ii in FIG. 1), we used ICP-OES techniques as a function of NaOH concentration and reaction time as shown in FIG. 3. The amount of elemental leaching gradually increases as the concentration of NaOH and reaction time increases. For the silica precipitation study, we used 1M NaOH concentration and 24 h reaction time for the carbonation experiment. Amino acids instigate the precipitation of elements Si, Al and Na present in the solution. We used X-ray photo emission spectroscopy (FIG. 4) and measured the percentage of various elements present on the precipitation. Table 1 shows that the precipitate has Na (5.18%) and C (7.14%) along with the Si and Al. The XRD pattern of the dried sample without acid wash as shown in FIG. 5 represents a peak at around 2θ~280 in addition to characteristic nano silica peak at around 2θ~24° in both the glycine and lysine assisted precipitated samples. To remove the precipitated Na and C from the nano-silica, we added an extra step after the precipitate separation process (step iv in FIG. 1). The precipitate was washed in water by centrifuge and then 0.001 N HNO₃ and then water in succession. Washing the precipitate with dilute acid removes Na and C from it and the extra peak at around 2θ~28° disappears (FIG. 6A), suggesting the extraction of nano silica. The broad peaks suggest the formation of nano silica.

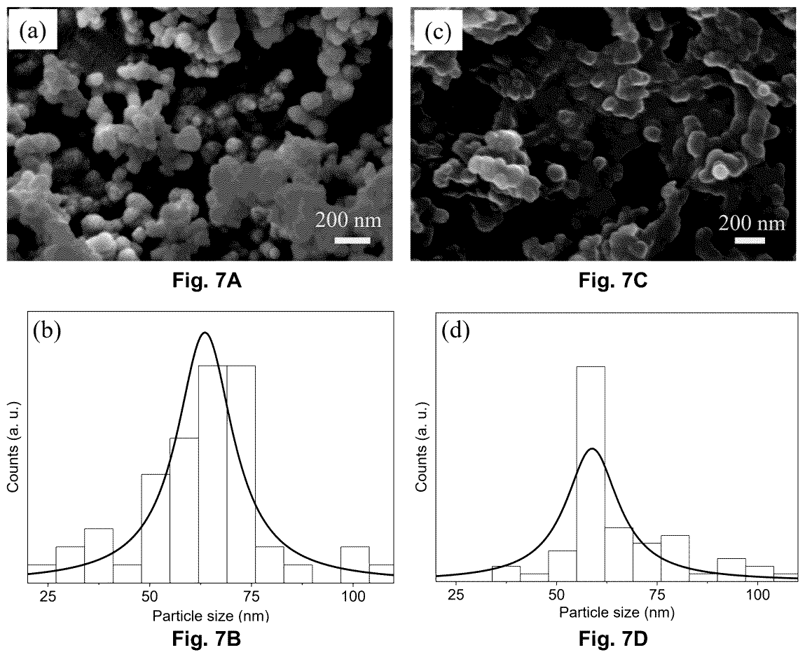

We also studied the surface area of the silica nano particles. The specific surface area was measured by Brunauer-Emmett-Teller (BET) method using N₂ adsorption isotherm at 77 K, as shown in FIG. 6B. N₂ adsorption isotherm analysis of glycine and lysine additive assisted nano silica in the P/Pₒ range 0.05 to 0.3 reveal a high specific surface area of 128.72 and 98.18 m²/gm, respectively (Table 2), also suggesting the nano-size of the precipitates. The inset in FIG. 6B shows the optical image of the nano silica dispersed in water. For further confirmation of the particle size of the precipitate, field effect emission spectroscopy was used, and the results are shown in FIGS. 7A-7D. FIGS. 7B and 7D show the particle size distribution histogram of the 1.25 M glycine and lysine assisted precipitate with 1 h precipitation time. The average particle size of the 1.25 M glycine and lysine assisted precipitates was 64.08±17.96 and 73.34±20.11 nm, respectively. Overall, the XPS, XRD, surface area, and morphology analysis reveal the successful extraction of nano silica from the leachate produced during the mineral carbonation process of steel slag.

TABLE 1
Atomic % of various elements present in
the precipitate obtained from XPS data.

| | Atomic % in | Atomic % after washing |
|---|---|---|
| Elements | precipitated silica | with 0.5M HNO₃ |
| Al 2p | 9.14 | 10.38 |
| Si 2p | 22.7 | 26.68 |
| C 1s | 7.24 | 1.17 |
| O 1s | 54.5 | 61.29 |
| Na 1s | 5.18 | 0.18 |
| Mg1s | 0.7 | 0.3 |

TABLE 2
Particle size, specific surface area and porosity of the
glycine and lysine assisted precipitated nano silica.

| | Amino acid | | | Specific | | |
|---|---|---|---|---|---|---|
| | concen- | Precip- | | surface | Pore | Pore |
| Amino | tration | itation | Particle | area | volume | width |
| acid | (M) | time (h) | size (nm) | (m²/gm) | (cc/gm) | (nm) |
| Glycine | 1.25 | 1 | 64.08 ± | 128.72 | 0.152 | 1.232 |
| | | | 17.96 | | | |
| Lysine | 1.25 | 1 | 73.34 ± | 98.18 | 0.088 | 1.232 |
| | | | 20.11 | | | |

We also performed NMR analysis to measure the concentrations of lysine and glycine remaining in the leachate after silica precipitation and separation. The results indicated that the peak height in the 1.25 M aqueous lysine or glycine solution remained nearly constant compared to the peak height in the leachate after silica precipitation and separation, suggesting minimal lysine and glycine precipitation with silica.

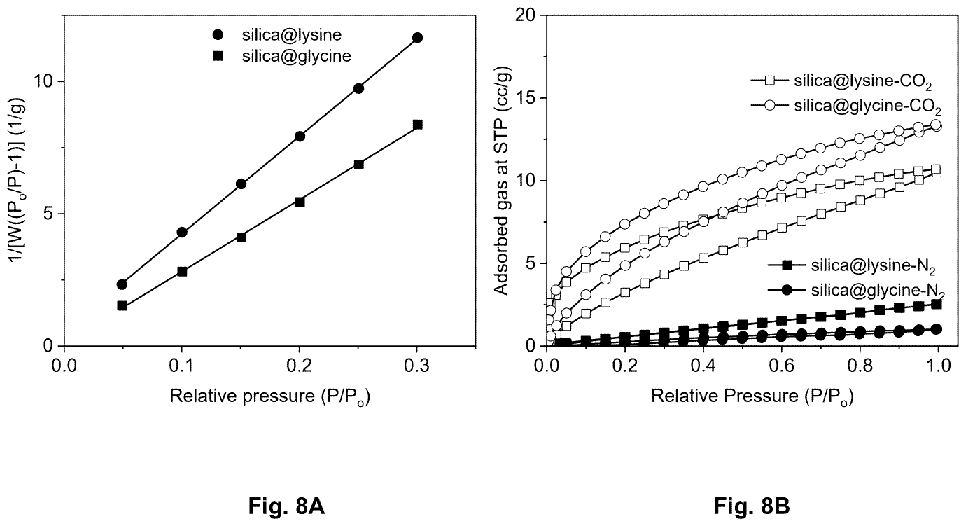

Various studies reported high surface area nano silica as a solid sorbent for CO₂ capture. Hence the high surface area of the precipitated silica (FIG. 8A) motivated us to study its CO₂ adsorption capacity. FIG. 8B represents the CO₂ and N₂ adsorption-desorption isotherm at room temperature (295 K) of the precipitated silica using 1.25 M glycine for 1 h and 1.25 M lysine for 1 h. The precipitated silica showed a CO₂ adsorption capacity of 0.59 and 0.47 mmol CO₂/gm sorbent at 1 atm CO₂, respectively. On the other hand, relatively poor N₂ adsorption suggests their promising CO₂ selectivity over N₂. The higher CO₂ adsorption capacity of nano-silica precipitated using glycine could attributed to its higher surface area than the nano silica precipitated using lysine.

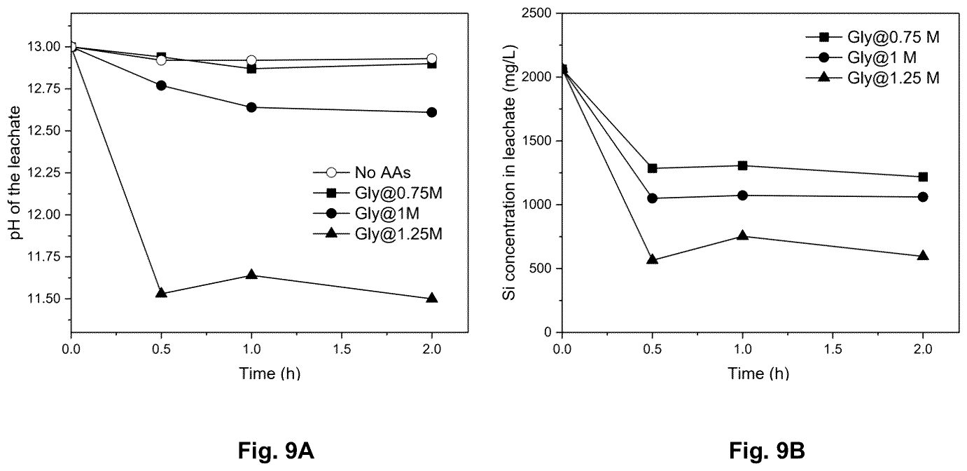

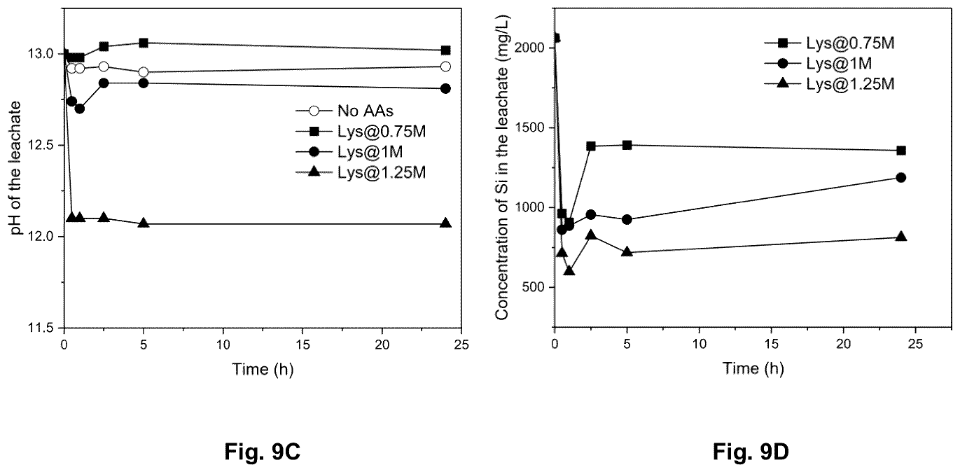

To optimize the required amino acid concentration in the leachate and precipitation time after adding the amino acids, we studied the pH of the leachate solution and amount of Si ion remained in the solution using different amino acids concentration in the range from 0.75 to 1.25 M, and varied the precipitation time from 30 min to 2 h as shown in FIGS. 9A-9D. FIGS. 9A and 9C shows the pH change of the leachate. The leachate with amino acids concentration 0.75 M to 1 M did not show significant change in pH as compared to the leachate without amino acids. Interestingly, leachate with 0.75 M lysine showed slightly higher pH than the leachate without amino acids. However, the leachate with amino acids concentration 1.25 M shows about 1 to 1.5 units reduction in pH, suggesting a loss of basicity which could potentially decrease the CO₂ carbonation efficiency in the next cycle. The pH study also reveals that the pH change occurs within the first 30 minutes of amino acids addition, which is consistent with the observation that the precipitation completes within the first 30 minutes as shown in FIGS. 9B and 9D. FIGS. 9B and 9D also reveals that nearly 50% of silica can be precipitated by using 0.75 to 1 M amino acids, without significantly reducing the pH and the leachate can be used for the next carbonation cycle.

### Recovery of Critical Metal Titanium

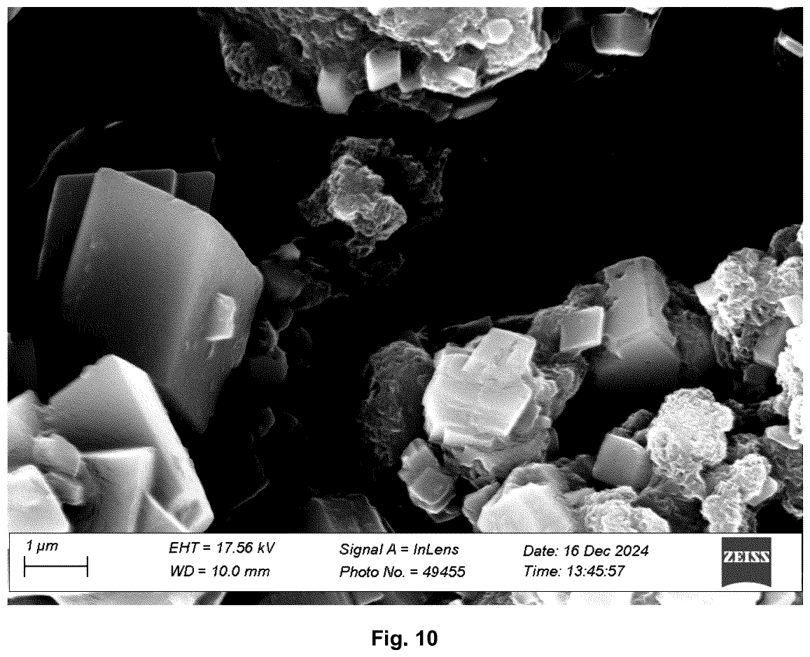

The ICP analysis indicates that the steel slag contains around 0.476 wt % of the critical metal titanium. No detectable amounts of other critical metals, such as Ni and Co, were observed in this steel plant slag. During the mineralization process using 1 M NaOH solution, we observed that carbonated steel slag contains 0.352 wt % titanium, suggesting that nearly 26% of titanium was leached out to the basic leachate. The percentage of titanium leaching can be further increased by reducing the steel slag particle size from the over micron size grains as shown in FIG. 10. Using higher concentration of NaOH could also enhance the titanium leaching. Both optimizations also increase CO₂ mineralization as well as silica extraction efficiency. The results of ICP-OES analysis show that the precipitated silica using 1.25 M glycine for 1 h without dilute acid wash and with dilute acid wash step contain nearly 0.028 wt % and 0.032 wt % titanium respectively. However, no titanium was observed in nano silica precipitated using 1.25 M lysine for 1 h. Based on the results, using lysine to precipitate silica, the leached titanium likely remains in the leachate and its concentration increases in the leachate after every cycle. When the titanium concentration in the leachate reaches a sufficient level, it can be separated using the current standard produce of chemical precipitation or electrodialysis.

In this Example, we have demonstrated an integrated strategy for CO₂ sequestration, value added product extraction and critical metals recovery using industrial waste steel slag. The recovered nano-silica has potential applications in various fields where nano-silica is commonly used, such as enhancing the cementitious properties of construction materials, advanced catalysis, drug delivery, biomedical applications, environmental remediation, the rubber and plastic industry, and wastewater treatment. Meanwhile, titanium finds applications in aerospace, spacecraft, automotive industries, medical devices and implants, marine engineering, jewelry, and alloy production. Further research may be conducted to optimize process parameters and conduct a comprehensive technoeconomic evaluation of the integrated technique. Additionally, this strategy can be extended to other types of solid alkaline waste, such as coal fly ash and cement kiln dust, which contain valuable elements such as calcium, silicon, lithium, rare earth elements, and other critical metals.

What is claimed is:

1. A method of synthesizing silica nanoparticles and recovering critical metals, the method comprising:
(a) providing a first solution containing dissolved silica, wherein the first solution is obtained by carbonation of a silicate-containing feedstock; and
(b) adding a zwitterion to the first solution in an amount sufficient to precipitate at least a portion of the dissolved silica to yield silica nanoparticles.

2. The method of claim 1, wherein the zwitterion comprises an acidic group with a pKa from about 1.0 to about 4.0, and a basic group with a pKa from about 6.0 to 13.0.

3. The method of claim 1, wherein the zwitterion is selected from the group consisting of amino acids, amino sulfonic acids, betaines, sulfobetaines, and phosphobetaines.

4. The method of claim 1, wherein the zwitterion is an amino acid.

5. The method of claim 4, wherein the amino acid is lysine or glycine.

6. The method of claim 1, wherein the yielded silica nanoparticles have an average size ranging from about 20 nm to about 350 nm, and a surface area ranging from about 50 m²/g to 250 m²/g, as measured by the Brunauer-Emmett-Teller (BET) method.

7. The method of claim 1, wherein the carbonation of the silicate-containing feedstock comprises contacting the silicate-containing feedstock with gaseous CO₂ in an aqueous alkaline solution or an aqueous alkaline solution containing soluble carbonate or bicarbonate salts to produce precipitated alkaline earth carbonates.

8. The method of claim 7, further comprising mechanically separating the precipitated alkaline earth carbonates from the aqueous alkaline solution to obtain the first solution.

9. The method of claim 1, wherein the silicate-containing feedstock comprises a ground natural mineral or an industrial alkaline waste.

10. The method of claim 9, wherein the ground natural mineral comprises at least one of olivine, serpentine, pyroxene, amphibole, feldspar, and wollastonite.

11. The method of claim 9, wherein the industrial alkaline waste comprises at least one of fly ash, bottom ash, slag, mine tailings, red mud, cement kiln dust, and crushed concrete.

12. The method of claim 1, wherein in step (b), the precipitation is conducted at about room temperature.

13. The method of claim 1, wherein in step (b), the precipitation is conducted for a time ranging from about 5 minutes to about 24 hours.

14. The method of claim 1, further comprising, following step (b):
(c) mechanically separating the yielded silica nanoparticles from the first solution to obtain separated silica nanoparticles and a second solution.

15. The method of claim 14, further comprising, following step (c):
(d) washing the separated silica nanoparticles with an acidic solution having an H⁺ concentration of less than 0.5 N.

16. The method of claim 15, wherein the acidic solution is HNO₃ with a concentration of about 0.001 N.

17. The method of claim 14, wherein the silicate-containing feedstock comprises at least one metal selected from cobalt, copper, lithium, titanium, nickel, niobium, tantalum, vanadium, tungsten, and rare earth metals, wherein at least a portion of the metal is present in the second solution.

18. The method of claim 17, further comprising recovering at least a portion of the metal from the second solution using precipitation, electrodialysis, membrane separation, solvent extraction, ion exchange, adsorption, or evaporation.

19. The method of claim 14, wherein the pH of the second solution differs from the first solution by no more than 2 units, and the method further comprising, following step (c):
(e) recycling the second solution into the carbonation of the silicate-containing feedstock, and repeating one or more cycles of steps (a), (b), (c), and (e).

20. The method of claim 19, wherein the silicate-containing feedstock comprises at least one metal selected from cobalt, copper, lithium, titanium, nickel, niobium, tantalum, vanadium, tungsten, and rare earth metals, wherein the concentration of the metal in the second solution increases with each cycle of steps (a), (b), (c), and (e).

21. The method of claim 20, further comprising recovering at least a portion of the metal from the second solution after the one or more cycles of steps (a), (b), (c), and (e) using precipitation, electrodialysis, membrane separation, solvent extraction, ion exchange, adsorption, or evaporation.
